(19) United States
(12) Patent Application Publication
(10) Pub. No.: US 2023/0416453 A1
(43) Pub. Date: Dec. 28, 2023

(54) Liquid Crystalline Polyesters (LCP) and Thermoplastic Compositions having Low Dielectric Constant (Dk) and Dissipation Factor (Df)

(71) Applicant: Solvay Specialty Polymers USA, LLC, Alpharetta, GA (US)

(72) Inventors: Ryan MONDSCHEIN, Cumming, GA (US); Joel POLLINO, Johns Creek, GA (US); Anthony BOCAHUT, Milano (IT)

(21) Appl. No.: 18/036,412

(22) PCT Filed: Nov. 29, 2021
(86) PCT No.: PCT/EP2021/083421

§ 371 Date: May 11, 2023

Related U.S. Application Data
(60) Provisional application No. 63/120,436, filed on Dec. 2, 2020.

(30) Foreign Application Priority Data
Feb. 15, 2021 (EP) 21157098.1

(51) Int. Cl. C08G 63/189; C08G 63/60

(52) U.S. Cl. CPC C08G 63/189; C08G 63/60

(57) ABSTRACT

The invention pertains to a Liquid Crystalline Polyester (LCP) and thermoplastic compositions comprising such LPC, exhibiting low dielectric constant and dissipation factors and being suitable for mobile electronic device components, for example films or structural components.

### CROSS-REFERENCE TO RELATED APPLICATIONS

This application claims priority to U.S. provisional application U.S. 63/120,436 filed on Dec. 2, 2020 and to European patent application EP 21157098.1 filed on Feb. 15, 2021, the whole content of these applications being incorporated herein by reference for all purposes.

### TECHNICAL FIELD

The present disclosure relates to Liquid Crystalline Polyesters (LCP) and thermoplastic compositions comprising such LCP, exhibiting low dielectric constant and dissipation factors and being suitable for mobile electronic device components, for example films or structural components.

### BACKGROUND ART

Due to their reduced weight and high mechanical performance, polymer compositions are widely used to manufacture mobile electronic device components. There is now a high demand from the market for polymer compositions to be used to manufacture mobile electronic device components having improved dielectric performances (i.e. low dielectric constants and dissipation factors).

In mobile electronic devices, the material forming the various components and housing can significantly degrade wireless radio signals (e.g. 1 MHz, 2.4 GHz, 5.0 GHz, 20.0 GHz frequencies) transmitted and received by the mobile electronic device through one or more antennas. The dielectric performances of the material to be used in mobile electronic devices can be determined by measuring the dielectric constant as it represents the ability of the material to interact with the electromagnetic radiation and disrupt electromagnetic signals (e.g. radio signals) travelling through the material. Accordingly, the lower the dielectric constant of a material at a given frequency, the less the material disrupts the electromagnetic signal at that frequency.

The Applicant has identified a new class of Liquid Crystalline Polyesters (LCP) having improved dielectric performances, which make them well-suited, notably, as materials for mobile electronic device components.

These LCP derive from a specific combination of components/monomers including aromatic monomers, as well as cyclohexane dicarboxylic acid. monomers.

US 2020/017769 (Kururay Co.) relates to a thermoplastic LCP capable of reducing a dielectric dissipation factor in high frequency bands as well as of having a controlled rise in the melting point. The LCP described in this document however does not comprise any cyclohexane dicarboxylic acid monomers, such as for example CHDA.

U.S. Pat. No. 6,093,787 (Eastman Chemical Company) relates to LCP which contain cyclohexanedicarboxylic acid (CHDA) moieties and to molding compositions comprising such LCP and glass fiber.

US 2020/0102420 (SK Chemicals) discloses LCP including an alicyclic dicarboxylic acid or its derivative. The alicyclic dicarboxylic acid or its derivative is introduced into the liquid crystal polymer, to improve the insulating property of the liquid crystal polymer. The alicyclic dicarboxylic acid or its derivative includes a cycloalkane dicarboxylic acid having 5 to 20 carbon atoms or an ester compound thereof. Preferably, 1,4-cyclohexanedicarboxylic acid (CHDA) can be used. The LCP described in these documents have high amounts of repeat units derived from hydroquinone and 4-hydroxybenzoic acid. They do not have the expected dielectric performances compared to the compositions of the present invention.

U.S. Pat. No. 4,355,133 (Celanese Corp) and U.S. Pat. No. 4,318,842 (Celanese Corp) both describe a melt processable polyester capable of forming an anisotropic melt phase at a temperature below approximately 350° C. consisting essentially of the following repeat units:

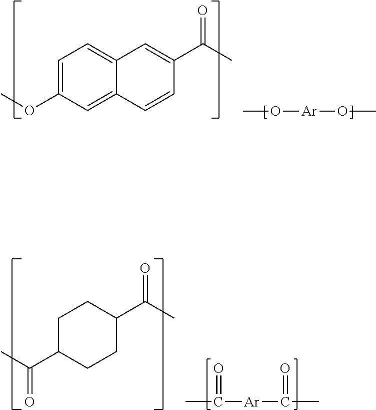

The polymers described in U.S. Pat. No. 4,318,842 comprise 10 to 40 mol. % of units III, preferably 15 to 25 mol. %, and most preferably 20 mol. %. All the examples in this document describe LCP polymers having between 15 and 30 mol. % of units III. The polymers described in U.S. Pat. No. 4,355,133 comprise 10 to 45 mol. % of units III. The only example of this document describes a LCP polymer containing 24.7 mol. % of units III. These polymers do not have the expected dielectric performances compared to the polymers of the present invention.

U.S. Pat. No. 5,747,175 (Hoechst) describes LCP blends having reproducible coloristic properties, stable temperatures for use in automobile finishes and high chemical resistance. The document generally describes the use of aromatic constituents for preparing LCP, but also mentions that it is possible to employ aliphatic and cycloaliphatic components, for example cyclohexanedicarboxylic acid. One example only in this document describes the use of CHDA in a molar content which amounts 10 mol. %.

None of the above-listed documents describe however the LCP of the present invention and their advantageous properties as a component of a mobile electronic device.

### SUMMARY OF INVENTION

An aspect of the present disclosure is directed to Liquid Crystalline Polyesters (LCP) comprising a specific combination of recurring units. The applicant has found that the combination of several repeats units in specific molar amounts leads to the preparation of a LCP resin having improved dielectric performances, as well as a set of thermal transition temperatures which make them most useful as materials for films and mobile electronic device articles or components.

Other aspects of the present invention are directed to thermoplastic compositions (C) comprising such LCP, process for preparing such LCP and compositions, as well as uses of such polymer products for preparing articles or components to be used in mobile electronic devices or transportation, including automotive.

### DESCRIPTION OF EMBODIMENTS

Described herein are Liquid Crystalline Polyesters (LCP) and thermoplastic compositions (C) comprising such LCP, having improved dielectric performances, which make them, notably, well-suited as materials for films and mobile electronic device articles or components. The LCP of the present invention are also well-suited for transportation (e.g. automotive, aeronautics, drones).

More specifically, the LCP of the present invention is manufactured from a specific molar amount of cyclohexane dicarboxylic acid constituent in combination with a selection of aromatic components and this specific combination of components has been shown to bring improved dielectric performances to the LCP or composition comprising such LCP, in comparison to LCP for example containing higher amount of cyclohexane dicarboxylic acid constituent.

Introduction of selected molar ratios of cyclohexanedicarboxylic acid (CHDA) has also been shown to enable the control of the melting temperature (Tm) and crystallization temperature (Tc) of the LCP, while maintaining liquid crystallinity, which is desirable for various processing requirements.

More precisely, the LCP of the present invention comprises:
from 40 to 98 mol. % of repeat units of formula (I):

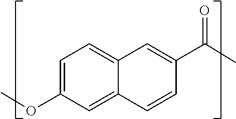

from 1 to 20 mol. % of repeat units of formula (IIa), (IIb), (IIc) and/or (IId):

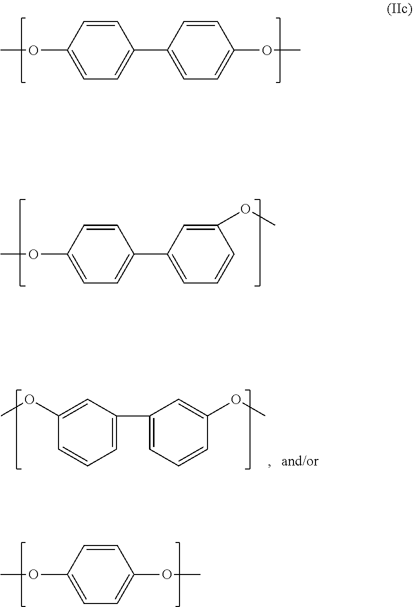

from 1 to 12 mol. % of repeat units of formula (IIIa) and/or (IIIb):

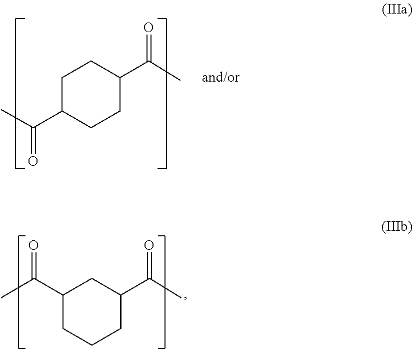

based on the total number of moles in the LCP.

The LCP described herein may be a LCP consisting essentially in the above-mentioned repeat units or a LCP comprising such repeat units, optionally comprising additional repeat units as described below.

In some embodiments, when the LCP of the present invention comprises additional repeat units, these repeat units may be chosen in the group consisting of:

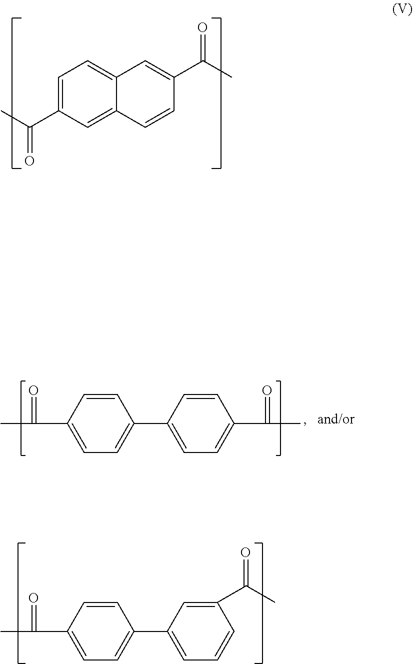

Each of these repeat units (IV), (V) and/or (VI) may be present in the LCP in a molar amount ranging from 0.1 and 15 mol. %, for example from 0.5 to 13 mol. %, from 1 to 11 mol. %, from 2 to 9 mol. % or from 3 to 8 mol. %, based on the total number of moles in the LCP.

In some other embodiments, when the LCP of the present invention comprises additional repeat units, the additional repeat units may be chosen in the group consisting of:

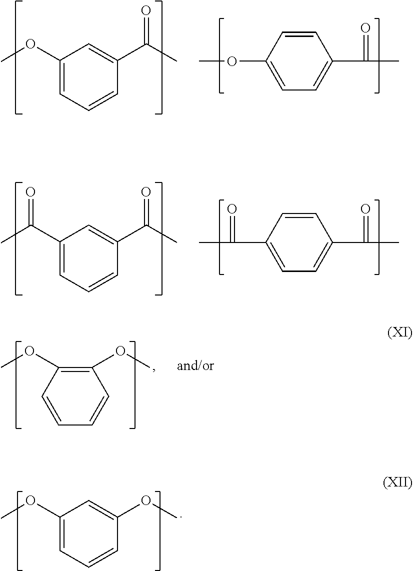

Each of these repeat units (VII), (VIII), (IX), (X), (XI) and/or (XI) may be present in the LCP in a molar amount ranging from 0.1 and 15 mol. %, for example from 0.5 to 13 mol. %, from 1 to 11 mol. %, from 2 to 9 mol. % or from 3 to 8 mol. %, based on the total number of moles in the LCP.

According to the present invention, when the LCP of the present invention comprises additional repeat units, these additional repeat units may be chosen from the group consisting of (IV), (V), (VI), (VII), (VIII), (IX), (X), (XI) and (XI). The LPC may comprise one, two, three, four, five, six, seven, eight or nine of these repeat units. Each of these repeat units may be present in the LCP in a molar amount ranging 0.1 and 15 mol. %, for example from 0.5 to 13 mol. %, from 1 to 11 mol. %, from 2 to 9 mol. % or from 3 to 8 mol. %, based on the total number of moles in the LCP.

In the present application
any description, even though described in relation to a specific embodiment, is applicable to and interchangeable with other embodiments of the present disclosure;
where an element or component is said to be included in and/or selected from a list of recited elements or components, it should be understood that in related embodiments explicitly contemplated here, the element or component can also be any one of the individual recited elements or components, or can also be selected from a group consisting of any two or more of the explicitly listed elements or components; any element or component recited in a list of elements or components may be omitted from such list; and
any recitation herein of numerical ranges by endpoints includes all numbers subsumed within the recited ranges as well as the endpoints of the range and equivalents.

In the present application, the term “comprising” (or “comprise”) includes “consisting essentially of” (or “consist essentially of”) and also “consisting of” (or “consist of”).

The use of the singular ‘a’ or ‘one’ herein includes the plural unless specifically stated otherwise.

Throughout this document, all temperatures are given in degrees Celsius (° C.).

The LCP of the present invention comprises repeat units (I), (II) and (III). As described throughout the application, repeat units (II) can be according to formula (IIa), (IIb), (IIc) and/or (IId). This means for example that the LCP of the present invention may comprise several distinct repeat units (II), for example (IIa) and (IId) or (IIa), (IIb) and (IIc). Preferably, the LCP of the present invention comprises repeat units (IIa) and/or (IId). The same holds true for repeat units (III), which can be according to formula (IIIa) and/or (IIIb). Preferably, the LCP of the present invention comprises repeat units (IIIa).

More specifically, the LCP of the present invention comprises from 40 to 98 mol. % of repeat units of formula (I), preferably from 40 to 90 mol. %, more preferably from 50 to 85 mol. % or from 60 to 81 mol. % of repeat units of formula (I), based on the total number of moles in the LCP. The LCP of the present invention further comprises from 1 to 22 mol. % of repeat units of formula (IIa), (IIb), (IIc) and/or (IId), preferably from 5 to 21 mol. % or from 10 to 20 mol. % of repeat units of formula (IIa), (IIb), (IIc) and/or (IId), based on the total number of moles in the LCP. The LCP of the present invention also comprises from 1 to 12 mol. % of repeat units of formula (IIIa) and/or (IIIb), preferably from 2 to 12 mol. %, or from 2 to 11 mol. %, or from 3 to 11 mol. %, or from 3 to 10 mol. % or from 4 to 9.5 mol. % or from 4.5 to 8.5 mol. % repeat units of formula (IIIa) and/or (IIIb), based on the total number of moles in the LCP. In these embodiments, the LCP may be made of the following monomers: 6-hydroxy-2-naphthoic acid (HNA) (or derivative, for example 6-acetoxy-2-naphthoic acid (AcHNA)), biphenol (BP) (or derivative, for example diacetoxybiphenyl (AcBP)), hydroquinone (HQ) (or derivative, for example diacetoxybenzene (AcHQ)), and cyclohexanedicarboxylic acid (CHDA). The CHDA monomer is generally a cis/trans isomer blend wherein the cis/trans ratio may vary between 1:99 to 99:1, for example varying between 10:90 and 90:10. For example, the LCP may be made of hydroxy-2-naphthoic acid (HNA) (or derivative), biphenol (BP) (or derivative) and/or hydroquinone (HQ) (or derivative), and cyclohexanedicarboxylic acid (CHDA). For example, the LCP may be made exclusively of these three or four monomers. Various isomers of biphenol (BP) can be used to prepare the LCP of the present invention. Biphenol (BP) may be for example be in the form of 4,4′-biphenol (4,4′-BP), 3,4′-biphenol (3,4′-BP) or 3,3′-biphenol (3,3′-BP). One or several of these isomers can be used. Preferably, at least 4,4′-biphenol is used to prepare the LCP of the present invention. Various isomers of hydroquinone (HQ) can also be used in the context of the present invention.

The LCP of the present invention may additionally comprises repeat units (IV), (V) and/or (VI). In these embodiments, the LCP may be made of the following monomers: 2,6-naphthalene dicarboxylic acid (NDA) (or derivative) and bibenzoic acid (BB) (or derivative). Various isomers of bibenzoic acid (BB) can be used to prepare the LCP of the present invention. Bibenzoic acid (BB) may be in the form of 4,4′-bibenzoic acid (4,4′-BB) and/or 3,4′-bibenzoic acid (3,4′-BB).

In some embodiments, the LCP of the present invention comprises:
from 65 to 75 mol. % of repeat units of formula (I),
from 13 to 18 mol. % of repeat units of formula (IIa), (IIb), (IIc) and/or (IId), and
from 3 to 9 mol. % of repeat units of formula (IIIa) and/or (IIIb),
   optionally at least one of the following repeat units:
from 3 to 11 mol. % of repeat units of formula (IV),
from 3 to 11 mol. % of repeat units of formula (V), and/or
from 3 to 11 mol. % of repeat units of formula (VI).

In some preferred embodiments, the LCP of the present invention comprises or consists essentially of:
from 65 to 75 mol. % of repeat units of formula (I),
from 13 to 18 mol. % of repeat units of formula (IIa), (IIb), (IIc) and/or (IId),
from 3 to 9 mol. % of repeat units of formula (IIIa) and/or (IIIb), and
optionally from 3 to 11 mol. % of repeat units of formula (IV).

The LCP of the present invention may additionally comprises repeat units (VII), (VIII), (IX), (X), (XI) and/or (XII). In these embodiments, the LCP may be made of the following monomers: hydroxybenzoic acid (HBA) (or derivative, for example acetoxybenzoic acid (AcHBA)), terephthalic acid (TPA) (or derivative), isophthalic acid (IPA) (or derivative), resorcinol (RS) (or derivative) and/or catechol (CT) (or derivative). In these embodiments, the LCP may be made of the following monomers: 6-hydroxy-2-naphthoic acid (HNA) (or derivative, for example 6-acetoxy-2-naphthoic acid (AcHNA)), biphenol (BP) (or derivative, for example diacetoxybiphenyl (AcBP)), hydroquinone (HQ) (or derivative, for example diacetoxybenzene (AcHQ)), cyclohexanedicarboxylic acid (CHDA), terephthalic acid (TPA) (or derivative) and/or isophthalic acid (IPA) (or derivative). For example, the LCP may be made exclusively of HNA (or derivative), BP or (derivative), HQ (or derivative), CHDA (or derivative), and TPA (or derivative). The LCP may also be made exclusively of HNA (or derivative), BP (or derivative), HQ (or derivative), CHDA (or derivative), and IPA (or derivative). The LCP may also be made exclusively of HNA (or derivative), BP (or derivative), HQ (or derivative), CHDA (or derivative), TPA (or derivative) and IPA (or derivative).

Various isomers of hydroxybenzoic acid (HBA) can be used to prepare the LCP of the present invention. Notably, HBA can be in the form of 4-hydroxybenzoic acid (4-HBA) and/or 3-hydroxybenzoic acid (3-HBA).

In some embodiments, the LCP of the present invention is such that the number of moles of repeat units is as follows:
formulas (I)+(II)+(III)+(IV)+(V)+(VI)+(VII)+(VIII)+(IX)+(X)+(XI)+(XII)=100 mol. %, wherein the number of moles of repeat units of formula (IV), (V), (VI), (VII), (VIII), (IX), (X), (XI) and/or (XII)>0 mol. %,
formulas (I)+(II)+(III)+(IV)+(V)+(VI)=100 mol. %, wherein the number of moles of repeat units of formula (IV), (V) and/or (VI) 0 mol. %, and
formulas (I)+(II)+(III)+(VII)+(VIII)+(IX)+(X)+(XI)+(XII)=100 mol. %, wherein the number of moles of repeat units of formula (VII), (VIII), (IX), (X), (XI) and/or (XII) 0 mol. %.

In these embodiments, the LCP may be made exclusively of the following monomers: 6-hydroxy-2-naphthoic acid (HNA) (or derivative), biphenol (BP) (or derivative), hydroquinone (HQ) (or derivative), cyclohexanedicarboxylic acid (CHDA) (or derivative), 2,6-naphthalene dicarboxylic acid (NDA) (or derivative), bibenzoic acid (BB) (or derivative).

For example, the LCP of the present invention may be such that the number of moles of repeat units is as follows:
formulas (I)+(II)+(III)=100 mol. %, for example formulas (I)+(IIa)+(IIIa)=100 mol. %,
formulas (I)+(II)+(III)+(IV)=100 mol. %, for example formulas (I)+(IIa)+(IIIa)+(IV)=100 mol. %,
formulas (I)+(II)+(III)+(V)=100 mol. %,
formulas (I)+(II)+(III)+(VI)=100 mol. %,
formulas (I)+(II)+(III)+(IX)=100 mol. %, or
formulas (I)+(II)+(III)+(X)=100 mol. %.

In some embodiments, the LCP may be made exclusively of the following monomers: 6-hydroxy-2-naphthoic acid (HNA) (or derivative), biphenol (BP) (or derivative), cyclohexanedicarboxylic acid (CHDA), preferably 1,4-CHDA, and 2,6-naphthalene dicarboxylic acid (NDA) (or derivative).

The LPC of the present invention is prepared from various entities, some of them being diols, dicarboxylic acids, hydroxycarboxylic acids, esters or diesters. The term “diol” refers to an organic compound having two hydroxyl groups, and preferably no other functional groups that can form ester linkages. The term “dicarboxylic acid” refers to an organic compound having two carboxyl groups, and preferably no other functional that can form ester linkages. The term “hydroxycarboxylic acid” refers to an organic compound having one hydroxyl group and one carboxyl group, and preferably no other functional groups which can form ester linkages. The terms “ester” or “diester” refer to organic compounds having one or two carboxyl groups (R¹CO₂—, wherein R¹ is alkyl or substituted alkyl) derived from carboxylic acids. In other words, the LPC of the present invention is prepared from of monomers having [—OH], [—OCOR¹] and [—COOH]. In some embodiments, the LCP is prepared from a molar ratio ([—OH]+[—OCOR¹])/[—COOH] ranging from 0.8 and 1.2, preferably from 0.9 and 1.1, even more preferably from 0.95 and 1.05. As an example, according to these embodiments, the molar ratio of repeat units ([II]+[XI]+[XII])/repeat units ([III]+[IV]+[V]+[VI]+[IX]+[X]) equals to 1±0.2, preferably 1±0.1, more preferably 1±0.05, even more preferably 1±0.01.

According to an embodiment, the LCP described herein has a melting temperature (Tm) above 260° C., for example ranging between 260 and 320° C., for example between 270 and 310° C., or between 280 and 300° C., as determined using differential scanning calorimetry (DSC) according to ASTM D3418 (cool-down, heating/cooling rate of 20° C./min).

According to an embodiment, the LCP described herein has a crystallization temperature (Tc) less than 260° C., for example ranging between 150 and 260° C., for example ranging between 155 and 250° C., or between 160 and 246° C., or between 160 and 240° C., as determined using differential scanning calorimetry (DSC) according to ASTM D3418 (cool-down, heating/cooling rate of 20° C./min).

According to an embodiment, the LCP or thermoplastic composition (C), objects of the present invention, preferably have a dielectric constant Dk at 5 GHz of less than 3.5, preferably less than 3.4, or less than or equal to 3.3, as measured in the in-plane direction on 4 cm×4 cm×150 μm (thickness) films obtained from the “dry-as-molded’ compression molded films, using a Split Cylinder Resonator (SCR method) according to ASTM D2520 (5 GHz).

According to an embodiment, the LCP or thermoplastic composition (C), objects of the present invention, preferably have a dissipation factor Df at 5 GHz of less than 0.0060, preferably less than 0.0058, or less than or equal to 0.0055, as measured in the in-plane direction on 4 cm×4 cm×150 μm (thickness) films obtained from the “dry-as-molded’ compression molded films, using a Split Cylinder Resonator (SCR method) according to ASTM D2520 (5 GHz).

According to an embodiment, the LCP or thermoplastic composition (C), objects of the present invention, preferably have a dielectric constant Dk at 20 GHz of less than 3.6, preferably less than 3.5, or less than or equal to 3.4, as measured in the in-plane direction on 4 cm×4 cm×150 μm (thickness) films obtained from the “dry-as-molded’ compression molded films, using a Split Cylinder Resonator (SCR method) according to ASTM D2520 (20 GHz).

According to an embodiment, the LCP or thermoplastic composition (C), objects of the present invention, preferably have a dissipation factor Df at 20 GHz of less than 0.0030, preferably less than 0.0025, or less than or equal to 0.0020, as measured in the in-plane direction on 4 cm×4 cm×150 μm (thickness) films obtained from the “dry-as-molded’ compression molded films, using a Split Cylinder Resonator (SCR method) according to ASTM D2520 (20 GHz). The LCP or thermoplastic composition (C), objects of the present invention, more preferably have a dissipation factor Df at 20 GHz of from 0.0010 to 0.0020 or from 0.0011 to 0.0019.

The LCP described herein can be prepared by any conventional method adapted to the synthesis of polyesters, more precisely LCPs.

The LCP described herein can for example be prepared by thermal polycondensation of monomers and comonomers. The LCP may contain a chain limiter, which is a monofunctional molecule capable of reacting with the hydroxyl or carboxylic acid moiety, and is used to control the molecular weight of the LCP. For example, the chain limiter can be acetic acid, propionic acid and/or benzoic acid. A catalyst can also be used. Examples of catalyst are phosphorous acid, ortho-phosphoric acid, meta-phosphoric acid, alkali-metal hypophosphite such as sodium hypophosphite and phenylphosphinic acid. A stabilizer, such as a phosphite, may also be used.

The LCP described herein can also advantageously be prepared by a solvent-free process, that-is-to-say a process conducted in the melt, in the absence of a solvent. When the condensation is solvent-free, the reaction can be carried out in equipment made from materials inert toward the monomers. In this case, the equipment is chosen in order to provide enough contact of the monomers, and in which the removal of volatile reaction products is feasible. Suitable equipment includes agitated reactors, extruders and kneaders.

Thermoplastic Composition (C)

The LCP described herein may be present in the thermoplastic composition (C) in a total amount of greater than 30 wt. %, greater than 35 wt. % by weight, greater than 40 wt. %, or greater than 45 wt. %, based on the total weight of the thermoplastic composition (C).

The LCP may be present in the thermoplastic composition (C) in a total amount of less than 99.95 wt. %, less than 99%, less than 95%, less than 90%, less than 80 wt. %, less than 70 wt. %, or less than 60 wt. %, based on the total weight of the thermoplastic composition (C).

The LCP may for example be present in the thermoplastic composition (C) in an amount ranging between 30 and 90 wt. %, for example between 40 and 80 wt. %, based on the total weight of the thermoplastic composition (C).

The thermoplastic composition (C) may also comprise one or more components selected from the group consisting of fillers (including reinforcing agents), tougheners, impact modifiers, plasticizers, colorants, pigments, antistatic agents, dyes, lubricants, thermal stabilizers, light stabilizers, flame retardants, nucleating agents and antioxidants.

A large selection of fillers (including reinforcing agents, also called reinforcing fibers or fillers) may be added to the composition (C) according to the present invention. They can be selected from fibrous and particulate reinforcing agents. A fibrous reinforcing filler is considered herein to be a material having length, width and thickness, wherein the average length is significantly larger than both the width and thickness. Generally, such a material has an aspect ratio, defined as the average ratio between the length and the largest of the width and thickness of at least 5, at least 10, at least 20 or at least 50. The filler may generally be selected from mineral fillers (such as talc, mica, kaolin, calcium carbonate, calcium silicate, magnesium carbonate), glass fibers, carbon fibers, synthetic polymeric fibers, aramid fibers, aluminum fibers, titanium fibers, magnesium fibers, boron carbide fibers, rock wool fibers, steel fibers and wollastonite. The fillers may be for example be low dielectric constant fiber filler or hollow fillers. The fillers may be electrically and non-electrically thermally conductive fillers, such as boron nitride, zinc oxide or graphene. In some embodiments, the thermoplastic composition (C) includes either boron nitride or zinc oxide. In one such embodiment, the thermoplastic composition (C) includes boron nitride and is free of zinc oxide. In the other embodiment, the thermoplastic composition (C) includes zinc oxide and is free of boron nitride. As used herein and unless explicitly stated otherwise, ‘free of’ a component means that the concentration of the component is no more than 1 wt. %, no more than 0.5 wt. %, no more than 0.1 wt. % or no more than 0.05 wt. %, based on the total weight of the thermoplastic composition (C).

The fillers (including reinforcing agents) may be present in the thermoplastic composition (C) in a total amount of greater than 5 wt. %, greater than 10 wt. % by weight, greater than 15 wt. % or greater than 20 wt. %, based on the total weight of the thermoplastic composition (C). The fillers may be present in the composition (C) in a total amount of less than 65 wt. %, less than 60 wt. %, less than 55 wt. % or less than 50 wt. %, based on the total weight of the polymer composition (C).

The fillers may for example be present in the composition (C) in an amount ranging between 5 and 65 wt. %, for example between 10 and 55 wt. %, based on the total weight of the thermoplastic composition (C).

In some embodiments, the composition (C) of the present invention may comprise a low dielectric constant fiber filler, specifically, a low dielectric constant glass fiber filler. It is desirable for the low dielectric constant filler to have a low dissipation factor Df. Notably, the low dielectric constant filler may have a Dk of less than 5.0 (about 4.5) at a frequency of from 1 megahertz (MHz) to 1 GHz and a Df of less than about 0.002 at a frequency of from 1 MHz to 1 GHz. In certain examples, the low dielectric constant filler is a dielectric glass fiber having a Dk of less than 5.0 at a frequency of from 1 MHz to 1 GHz and a Df of less than about 0.002 at a frequency of from 1 MHz to 1 GHz.

In exemplary aspects, the composition (C) comprises glass fibers, for example low dielectric constant fiber fillers, and they may be selected from E-glass, S-glass, AR-glass, T-glass, D-glass R-glass, and combinations thereof. As an example, the glass fiber can be an “E” glass type which is a class of fibrous glass filaments included of lime-alumino-borosilicate glass.

The glass fibers, for example low dielectric constant glass fibers, which may be used in the compositions (C) of the present invention can have a variety of shapes. The fibers may include milled or chopped glass fibers. They may be in the form of whiskers or flakes. In further examples, they may be short glass fiber or long glass fiber. The glass fibers may have a length of about 4 mm (millimeter) or longer are referred as to long fibers, and fibers shorter than this are referred to as short fibers. In one aspect, the diameter of the glass fibers can be 10 μm (microns), or from 2 μm to 15 μm, or from 5 μm to 12 μm.

The glass fibers, including the low dielectric constant glass fiber, may have a round, flat, or irregular cross-section. Glass fibers having non-round cross-sections may be used in the composition of the present invention. Alternatively, the glass fiber may have circular cross-sections. The diameter of the glass fiber may for example be from about 1 to about 15 μm. More specifically, the diameter of the low dielectric constant glass fiber may for example be from about 4 to about 10 μm. Flat glass fibers may also be used, for example flat glass fibers from Nitto Boseki Co., LTD (CSG 3PA-830).

The fillers which may be present in the composition (C) of the present invention may be surface-treated with a surface treatment agent containing a coupling agent to improve adhesion to the polymer base resin. Suitable coupling agents can include, but are not limited to, silane-based coupling agents, titanate-based coupling agents or a mixture thereof. Applicable silane-based coupling agents include aminosilane, epoxysilane, amidesilane, azidesilane and acrylsilane. Organo metallic coupling agents, for example, titanium or zirconium-based organo metallic compounds, may also be used.

The composition (C) of the present invention may also comprise hollow fillers. The hollow filler may for example be hollow glass spheres, hollow glass fibers, or a hollow ceramic spheres. In specific examples, the hollow filler may be a hollow glass sphere. Exemplary hollow glass spheres have a density of from 0.2 grams per cubic centimeter (g/cm³). For example, suitable hollow glass spheres have a density of about 0.46 g/cm³. In a further example, suitable hollow glass spheres have a density of about 0.6 g/cm³. The hollow glass sphere may have a diameter of from 5 μm to 50 μm. For example, suitable hollow glass spheres have a diameter of about 30 μm 2, or about 20 μm±2. Another suitable hollow glass sphere may have a diameter of about 10 μm±2.

The thermoplastic composition (C) of the present invention may also comprise a toughener, also called impact modifier. A toughener is generally a low glass transition temperature (Tg) polymer, with a Tg for example below room temperature, below 0° C. or even below −25° C. As a result of its low Tg, the toughener is typically elastomeric at room temperature. Tougheners can be functionalized polymer backbones.

The toughener may for example be a siloxane-based toughener.

The polymer backbone of the toughener can be selected from elastomeric backbones comprising polyethylenes and copolymers thereof, e.g. ethylene-butene; ethylene-octene; polypropylenes and copolymers thereof; polybutenes; polyisoprenes; ethylene-propylene-rubbers (EPR); ethylene-propylene-diene monomer rubbers (EPDM); ethylene-acrylate rubbers; butadiene-acrylonitrile rubbers, ethylene-acrylic acid (EAA), ethylene-vinylacetate (EVA); acrylonitrile-butadiene-styrene rubbers (ABS), block copolymers styrene ethylene butadiene styrene (SEBS); block copolymers styrene butadiene styrene (SBS); core-shell elastomers of methacrylate-butadiene-styrene (MBS) type, or mixture of one or more of the above.

When the toughener is functionalized, the functionalization of the backbone can result from the copolymerization of monomers which include the functionalization or from the grafting of the polymer backbone with a further component.

Specific examples of functionalized tougheners are notably terpolymers of ethylene, acrylic ester and glycidyl methacrylate, copolymers of ethylene and butyl ester acrylate; copolymers of ethylene, butyl ester acrylate and glycidyl methacrylate; ethylene-maleic anhydride copolymers; EPR grafted with maleic anhydride; styrene copolymers grafted with maleic anhydride; SEBS copolymers grafted with maleic anhydride; styrene-acrylonitrile copolymers grafted with maleic anhydride; ABS copolymers grafted with maleic anhydride.

The toughener may be present in the composition (C) in a total amount of greater than 1 wt. %, greater than 2 wt. % or greater than 3 wt. %, based on the total weight of the thermoplastic composition (C). The toughener may be present in the thermoplastic composition (C) in a total amount of less than 30 wt. %, less than 20 wt. %, less than 15 wt. % or less than 10 wt. %, based on the total weight of the thermoplastic composition (C).

The thermoplastic composition (C) may also comprise other conventional additives commonly used in the art, including plasticizers, colorants, pigments (e.g. black pigments such as carbon black and nigrosine), antistatic agents, dyes, lubricants (e.g. linear low density polyethylene, calcium or magnesium stearate or sodium montanate), thermal stabilizers, light stabilizers, flame retardants, nucleating agents, mold release agents and antioxidants.

In various aspects, the thermoplastic composition (C) can comprise a mold release agent. Exemplary mold releasing agents can include for example, metal stearate, stearyl stearate, pentaerythritol tetrastearate, beeswax, montan wax, paraffin wax, or the like, or combinations including at least one of the foregoing mold release agents. Mold releasing agents are generally used in amounts of from about 0.1 to about 1.0 parts by weight, based on 100 parts by weight of the total thermoplastic composition (C), excluding any filler.

The thermoplastic composition (C) may also comprise one or more other polymers, for example a LCP distinct from the LCP of the present invention or for example a polyethylene glycol (PEG), a polyethylene terephthalate (PET), or a polyethylene naphthalate (PEN).

Preparation of the Thermoplastic Composition (C)

Also described herein is a method of making the thermoplastic composition (C) as detailed above. In fact, the thermoplastic composition (C) of the invention can be prepared according to a variety of methods. The compositions of the present disclosure can be blended, compounded, or otherwise combined with the aforementioned ingredients by a variety of methods involving intimate mixing/admixing of the materials with any additional additives desired in the formulation. Said preparation method for example comprising melt-blending the LCP and the specific components, e.g. a filler, a toughener, a stabilizer, and of any other optional additives.

Any melt-blending method may be used for mixing polymeric ingredients and non-polymeric ingredients in the context of the present invention. For example, polymeric ingredients and non-polymeric ingredients may be fed into a melt mixer, such as single screw extruder or twin screw extruder, agitator, single screw or twin screw kneader, or Banbury mixer, and the addition step may be addition of all ingredients at once or gradual addition in batches. When the polymeric ingredient and non-polymeric ingredient are gradually added in batches, a part of the polymeric ingredients and/or non-polymeric ingredients is first added, and then is melt-mixed with the remaining polymeric ingredients and non-polymeric ingredients that are subsequently added, until an adequately mixed composition is obtained. If a reinforcing agent presents a long physical shape (for example, a long glass fiber), drawing extrusion molding may be used to prepare a reinforced thermoplastic composition (C).

Articles and End-Use Applications

The present invention relates to articles comprising the LCP or the thermoplastic composition (C) described herein.

The LCP or thermoplastic composition (C) of the present invention can be in various forms. For example, they can be in powder form, fiber form or particle form. They can also be in liquid form.

Any process known to the skilled person in the art can be used to produce powders, fibers or particles of LCP, including mechanical, solution, and melt methods. Mechanical processes include grinding and milling solid LCP (for example, cryogrinding, jetmilling, ballmilling or similar). Solution processing includes coagulation/precipitation of a soluble or semi-soluble LCP (for example, solution coagulation or prilling). Fibers can be produce by melt spinning, solution spinning or similar. Fibers can either be monofilament or bicomponent filament, such as core-sheath and side-by-side.

The LCP or thermoplastic composition (C) of the present invention can be used as fillers or additives in dispersions, solutions, films and injection molded specimens.

For example, powders can be used as additives in dispersions, notably dispersions of polyamides/polyimides solutions, LCP solutions or polysulfones solutions. They can also be used as a matrix to coalesce into a film or 3D object. They can also be used as material to injection mold, for example in narrow pitch connectors, thin-walled parts, cases, microswitches, structural material for cameras. They can also be used as a filler/additive into resins for injection molded parts, such as structural components, antennas and base stations.

Fibers could be used in spun bonding, as staple fibers, and chopped as a reinforcing agent/filler. With respect to fibers, potential processes to produce fibers include melt spinning, solution spinning or similar. They can either be monofilament or bicomponent filament (ex: core-sheath, side-by-side).

The LCP or thermoplastic composition (C) of the present invention may be shaped in the form of a film, for example flexible printed circuit boards (FPCs).

The LCP or thermoplastic composition (C) may also be injection molded for structural components of microelectronics and smart devices, mobile electronic device, that-is-to-say an electronic device that is intended to be conveniently transported and used in various locations. A mobile electronic device can include, but is not limited to, a mobile phone, a personal digital assistant (“PDA”), a laptop computer, a tablet computer, a wearable computing device (e.g., a smart watch, smart glasses and the like), a camera, a portable audio player, a portable radio, global position system receivers, and portable game consoles.

The LCP and the thermoplastic compositions (C) described herein achieve dielectric performance that can be attributed to a synergy among the LCP constituents. LCP and the thermoplastic compositions (C) of the present invention also present an advantageous set of thermal properties (e.g. Tm and Tc), while maintaining liquid crystalline morphology. This is notably desirable for forming films of LCP. More precisely, the inventors have realized that the LCP of the present invention present a set of Tc and Tm which makes them well-suited for being processed in the form of films. Notably, their Tc is preferably below 260° C. and their Tm is above 260° C. as described above. The LCP of the present invention can withstand the assembly processing steps in the microelectronic space. Various lamination/surface mount technologies (SMT) use temperatures above 260° C.; it is thus clearly an advantage that the LCP have a Tm above 260° C., for example from around 280° C. to 300° C.

According to an embodiment, the mobile electronic device component may, for example, comprise a radio antenna and the composition (C). In this case, the radio antenna can be a WiFi antenna or an RFID antenna. The mobile electronic device component may also be an antenna housing.

In some embodiments, the mobile electronic device component is an antenna housing. In some such embodiments, at least a portion of the radio antenna is disposed on the thermoplastic composition (C). Additionally or alternatively, at least a portion of the radio antenna can be displaced from the thermoplastic composition (C). In some embodiments, the device component can be of a mounting component with mounting holes or other fastening device, including but not limited to, a snap fit connector between itself and another component of the mobile electronic device, including but not limited to, a circuit board, a microphone, a speaker, a display, a battery, a cover, a housing, an electrical or electronic connector, a hinge, a radio antenna, a switch, or a switchpad. In some embodiments, the mobile electronic device can be at least a portion of an input device.

In some embodiments, the mobile electronic device part or component is used in transportation, for example automotive (e.g. smart car/intelligent car with 5G capabilities), aeronautics and drones.

In a further aspect, the molded articles can be used to manufacture articles, devices or components in the transportation field, notably the automotive field. In a still further aspect, non-limiting examples of such devices in the automotive field which can use the disclosed blended thermoplastic compositions (C) in the vehicle's interior include adaptive cruise control, headlight sensors, windshield wiper sensors, and door/window switches. In a further aspect, non-limiting examples of devices in the automotive field which can the disclosed blended thermoplastic compositions (C) in the vehicle's exterior include pressure and flow sensors for engine management, air conditioning, crash detection, and exterior lighting fixtures.

The disclosure of all patent applications, and publications cited herein are hereby incorporated by reference, to the extent that they provide exemplary, procedural or other details supplementary to those set forth herein. Should the disclosure of any patents, patent applications, and publications which are incorporated herein by reference conflict with the description of the present application to the extent that it may render a term unclear, the present description shall take precedence.

### EXAMPLES

These examples demonstrate the thermal and dielectric performances of inventive or comparative LCP.

Raw Materials

AcHNA: 6-acetoxy-2-naphthoic acid, commercially available from TCI (Tokyo Chemical Industry).

AcBP: 4,4′-diacetoxybiphenyl, commercially available from TCI.

CHDA: 1,4-cyclohexanedicarboxylic acid, commercially available from Sigma Aldrich (cis/trans ratio is 78.5:21.5)

NDA: 2,6-naphthalene dicarboxylic acid, commercially available from TCI.

4,4′-BB: 4,4′-bibenzoic acid, commercially available from TCI.

Comparative LCP Resin 1

Reactions were performed in a dried 100 mL round bottomed flask equipped with an overhead stirrer, nitrogen inlet, and distillation neck attached to a receiving flask. 33.68 g of AcHNA (70 mol. %), 5.40 g of CHDA (15 mol. %) and 8.47 g (15 mol. %) of AcBP were added. Subsequent degassing with vacuum and N2 gas purging (3×) produced an oxygen-free environment. The initial temperature was 220° C. or the temperature where all monomers formed a melt and this temperature was held and stirred for 0.5 h. The temperature was increased at 1.0° C./min from the starting temperature until 335° C., where it was held for 1 h. House vacuum was then applied to promote removal of acetic acid condensate for 0.5-1 h followed by application of high vacuum, reaching 0.1-2 mmHg. The reaction was held under high vacuum until no noticeable condensate was seen leaving the reaction and the polymer sample solidified around the stir blade. The sample was subsequently cooled and retrieved from the stir blade. LCP were dried at 100° C. overnight before use.

Inventive LCP Resin 2

This example follows the previous procedure with 33.07 g (70 mol. %) of AcHNA, 3.11 g (7 mol. %) of NDA, 2.83 g (8 mol. %) of CHDA, and 8.32 g (15 mol. %) of AcBP as monomer charges.

Comparative LCP Resin 3

This example follows the previous procedure with 29.02 g (60 mol. %) of AcHNA, 7.24 g (20 mol. %) of CHDA, and 11.36 g (20 mol. %) of AcBP as monomer charges.

Inventive LCP Resin 4

This example follows the previous procedure with 32.72 g (70 mol. %) of AcHNA, 3.44 g (7 mol. %) of 4,4′BB, 2.80 g (8 mol. %) of CHDA, and 8.23 g (15 mol. %) of AcBP as monomer charges.

Inventive LCP Resin 5

This example follows the previous procedure as with Inventive LCP Resin 2 but with 70 mol. % of AcHNA, 15 mol. % of AcBP, 10 mol. % of NDA and 5 mol. % of CHDA as monomer charges.

Preparation of Films

Compression molding utilized two stainless steel plates layered with Kapton films and an aluminum shim to control thickness (0.004″). Samples were heated for approximately 3 min at Tm+20° C. before placing the top plate. The sandwich was centered in the press and it was closed to ensure contact with both upper and lower platens. After 2 min of heating at Tm+20° C., four press-release-press cycles with 2 tons of force for the first two cycles and 4 tons of force for the last two cycles finished the film compression molding procedure. The sandwich was immediately removed from the press and placed on a cool benchtop and allowed to return to ambient temperature over at least 1 h. The films were then removed from the sandwich and placed in an inert oven using N₂ gas and annealed at 200° C. for 18 h.

Testing

Thermal Transitions (Tg, Tm)

The glass transition and melting temperatures of the various LCP were measured using differential scanning calorimetry according to ASTM D3418 employing a heating and cooling rate of 20° C./min. Three scans were used for each DSC test: a first heat up to 340° C., followed by a first cool down to 30° C., followed by a second heat up to 350° C. The Tm was determined from the second heat-up and the Tc was determined from the cool-down. The melting temperatures are tabulated in Table 1 below.

Compression Molding & Dielectric Performances

The compression molding of 4″×4″×0.006″ squares was conducted with dried granulated polymers using a Carver 8393 Laboratory Press. The dielectric constant Dk and dissipation factor Df were measured on 4 cm×4 cm×150 μm (thickness) films obtained from the “dry-as-molded’ compression molded films. The dielectric constant Dk and dissipation factor Df in the in-plane direction were measured using a Split Cylinder Resonator (SCR method) according to ASTM D2520.

Results

The films made from inventive Resins 2, 4, 5 (with 5 to 8 mol % CHDA) had a dissipation factor Df at 20 GHz from 0.0011 to 0.0019, while the films made from comparative Resins 1 and 3 (with 15 and 20 mol % CHDA) had a higher dissipation factor Df at 20 GHz at 0.0031 and 0.0046.

TABLE 1

| | | Resin 2 | | Resin 4 | Resin 5 |
|---|---|---|---|---|---|
| Monomers | Resin 1 | (Inven- | Resin 3 | (inven- | (Inven- |
| (mol. %) | (comp.) | tive) | (comp.) | tive) | tive) |
| AcHNA | 70 | 70 | 60 | 70 | 70 |
| AcBP | 15 | 15 | 20 | 15 | 15 |
| CHDA | 15 | 8 | 20 | 8 | 5 |
| NDA | — | 7 | — | — | 10 |
| 4,4′-BB | — | — | — | 7 | — |

Thermal and dielectric properties

| | | | | | |
|---|---|---|---|---|---|
| Tc (° C.) | 238 | 223 | 259 | 240 | 246 |
| Tm (° C.) | 301, 321 | 288 | 313 | 298 | 300 |
| Tm ΔH (J/g) | 0.9, 0.6 | 1 | 2.4 | 1.1 | 2.9 |
| Dk 20 GHz | 3.6 | 3.4 | 3.4 | 3.3 | 3.4 |
| Df 20 GHz | 0.0031 | 0.0019 | 0.0046 | 0.0011 | 0.0014 |

1. A liquid crystalline polyester (LCP), comprising:
from 40 to 98 mol. % of repeat units of formula (I): 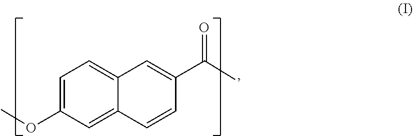
from 1 to 20 mol. % of repeat units of formula (II): 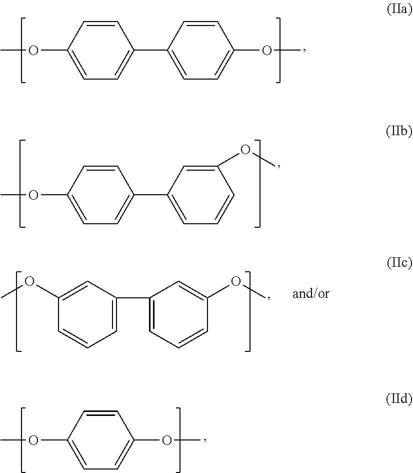
and
from 1 to 12 mol. % of repeat units of formula (III): 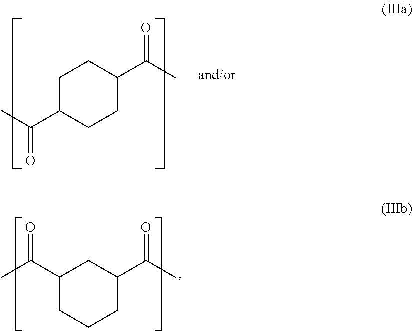
based on the total number of moles in the LCP.

2. The LCP of claim 1, further comprising:
from 0.1 to 15 mol. % of repeat units of formula (IV): 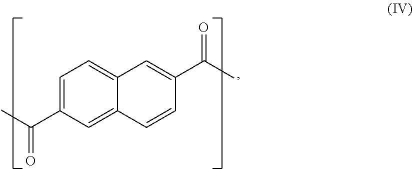
from 0.1 to 15 mol. % of repeat units of formula (V): 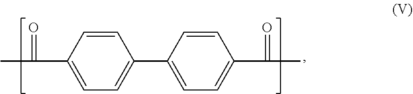
and/or
from 0.1 to 15 mol. % of repeat units of formula (VI):

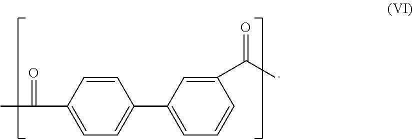

3. The LCP of claim 1, further comprising:
from 0.1 to 15 mol. % of repeat units of formula (VII): 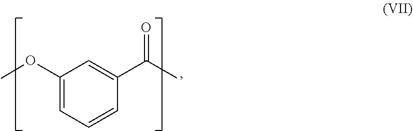
from 0.1 to 15 mol. % of repeat units of formula (VIII): 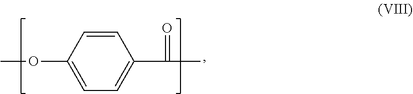
from 0.1 to 15 mol. % of repeat units of formula (IX) 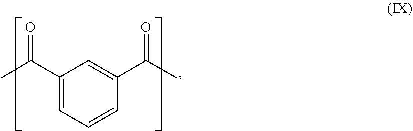
from 0.1 to 15 mol. % of repeat units of formula (X): 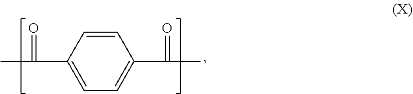
and/or
from 0.1 to 15 mol. % of repeat units of formula (XI): 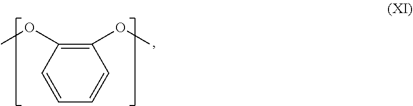
and/or
from 0.1 to 15 mol. % of repeat units of formula (XII):

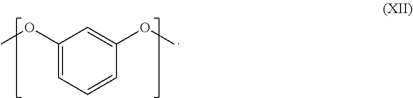

4. The LCP of claim 1, comprising:
from 40 to 90 mol. % of repeat units of formula (I),
from 10 to 20 mol. % of repeat units of formula (II) and
from 2 to 12 mol. % of repeat units of formula (III).

5. The LCP of claim 1, comprising:
from 65 to 85 mol. % of repeat units of formula (I),
from 13 to 18 mol. % of repeat units of formula (II), and
from 3 to 11 mol. % of repeat units of formula (III),
optionally at least one of the following repeat units:
from 1 to 11 mol. % of repeat units of formula (IV),
from 1 to 11 mol. % of repeat units of formula (V), and/or
from 1 to 11 mol. % of repeat units of formula (VI).

6. The LCP of claim 1, wherein the number of moles of repeat units of:
formulas (I)+(II)+(III)=100 mol. %,
formulas (I)+(II)+(III)+(IV)=100 mol. %,
formulas (I)+(II)+(III)+(V)=100 mol. %,
formulas (I)+(II)+(III)+(VI)=100 mol. %
formulas (I)+(II)+(III)+(IX)=100 mol. %, or
formulas (I)+(II)+(III)+(X)=100 mol. %.

7. The LCP of claim 1, resulting from the condensation of:
from 40 to 98 mol. % of 6-hydroxy-2-naphthoic acid (HNA) and/or 6-acetoxy-2-naphthoic acid (AcHNA),
from 1 to 20 mol. % of 4,4′-biphenol (BP), hydroquinone (HQ), 4,4′-diacetoxybiphenyl (AcBP) and/or 1,4-diacetoxybenzene (AcHQ), and
from 1 to 12 mol. % of cyclohexanedicarboxylic acid (CHDA).

8. The LCP of claim 1, resulting from the condensation of monomers having [—OH], [—OCOR¹] and [—COOH], wherein the molar ratio ([—OH]+[—OCOR¹])/[—COOH] ranges from 0.8 and 1.2.

9. A thermoplastic composition (C), comprising the LCP of claim 1, and optionally at least one component selected from the group consisting of reinforcing agents, tougheners, plasticizers, colorants, pigments, antistatic agents, dyes, lubricants, thermal stabilizers, light stabilizers, flame retardants, nucleating agents and antioxidants.

10. A mobile electronic device article or component, comprising the LCP of claim 1.

11. The article or component of claim 10, wherein the LCP has:
a dielectric constant Dk at 5 GHz of less than 3.5, as measured according to ASTM D2520 (5 GHz), and/or
a dissipation factor Df at 5 GHz of less than 0.0060, as measured according to ASTM D2520 (5 GHz), and/or
a dielectric constant Dk at 20 GHz of less than 3.6, as measured according to ASTM D2520 (20 GHz), and/or
a dissipation factor Df at 20 GHz of less than 0.0030, as measured according to ASTM D2520 (20 GHz).

12. The article or component of claim 10, being in the form of a film.

13. A method to prepare a mobile electronic device, article or component, comprising using the LCP of claim 1.

14. The method of claim 13, wherein the device, article or component is used in mobile electronic devices or transportation.

15. A method to control the melting temperature (Tm) and crystallization temperature (Tc) of a liquid crystalline polyester (LCP), while maintaining liquid crystallinity, comprising introducing a molar ratio of cyclohexanedicarboxylic acid (CHDA) to a liquid crystalline polyester (LCP) comprising at least from 40 to 98 mol. % of 6-hydroxy-2-naphthoic acid (HNA) or 6-acetoxy-2-naphthoic acid (AcHNA) and at least 1 to 20 mol. % of one dihydroxy aromatic compound, wherein the molar ratio of CHDA is between 1 and 12 mol. %, said mol. % being based on the total number of moles in the LCP.

16. The LCP of claim 7, wherein the cyclohexanedicarboxylic acid (CHDA) is 1,4-cyclohexanedicarboxylic acid (1,4-CHDA).

17. The article or component of claim 12, being a flexible printed circuit board (FPC).
